(19) United States
(12) Patent Application Publication
(10) Pub. No.: US 2011/0087591 A1
(43) Pub. Date: Apr. 14, 2011

(54) Personalization Data Creation or Modification Systems and Methods

(76) Inventors: Tim Barnett, Roswell, GA (US); Ashish Bahl, Ponte Vedra Beach, FL (US); Nandan S. Sheth, Atlanta, GA (US)

(21) Appl. No.: 12/575,710

(22) Filed: Oct. 8, 2009

(51) Int. Cl. G06Q 40/00

(52) U.S. Cl. 705/44

(57) ABSTRACT

The present disclosure has a merchant computing device communicatively coupled to a customer computing device via a network and a transaction computing device securely coupled to the merchant computing device and coupled to a debit network. In addition, the present disclosure has logic configured to enable a user of the customer computing device to modify personalization data stored on the transaction computing device based upon an approval obtained via the debit network during a transaction with the merchant computing device. In addition, the personalization data comprises a phrase and an image and the logic is further configured to display the phrase and the image to the user when the user performs a transaction with the transaction computing device.

### BACKGROUND

Typically, phishing refers to a process in the computer security arena, whereby an individual masquerades as a trusted source in an attempt to obtain sensitive information from a computer and/or network. Such sensitive information may include, for example, usernames, passwords, credit card numbers, or personal identification numbers (PINs).

In one scenario, a computer user may receive an email that appears for all intents and purposes to be a legitimate email from a legitimate source. Within the email is a hyperlink that, when selected, directs the computer user to a web site that requests sensitive information. The website may comprise, for example, a pin pad, and the website may prompt the user to enter a security PIN or other sensitive information. However, the website is fraudulent in that it is owned or maintained by an entity unauthorized to access the sensitive information. Unless the computer or computer user recognizes the website as being fraudulent, the computer user may unknowingly provide information through the website to the unauthorized entity.

Some of these fraudulent websites can be very persuasive. In this regard, a fraudulent website may falsely display valid logos to make it appear that the website is supported by the source of the logo. A fraudulent website may also have a domain name that appears to be a valid domain name. Thus, discovery that a website is fraudulent may be difficult increasing the likelihood that a computer user will be tricked into entering his/her sensitive information into the website.

### BRIEF DESCRIPTION OF THE DRAWINGS

FIG. 1 is a block diagram illustrating an exemplary embodiment of an on-line commercial transaction system.

FIG. 2 is a block diagram illustrating an exemplary embodiment of a transaction computing device depicted in FIG. 1.

FIG. 3 depicts an exemplary “Continue” graphical user interface (GUI) displayed by the transaction computing device of FIG. 2.

FIG. 4 depicts an exemplary a personal identification number (PIN) pad GUI displayed by the transaction computing device of FIG. 2.

FIG. 5 depicts an exemplary information input GUI displayed by the transaction computing device of FIG. 2.

FIG. 6 depicts an exemplary a password entry GUI displayed by the transaction computing device of FIG. 2.

FIG. 7 depicts an exemplary information display GUI displayed by the transaction computing device of FIG. 2.

FIG. 8 is a flowchart illustrating an exemplary method of performing a commercial transaction.

### DETAILED DESCRIPTION

The present disclosure generally pertains to on-line commercial transaction systems and methods. In one exemplary embodiment, a transaction computing device receives, from a merchant computing device via a secured connection, data indicative of a commercial transaction, such as an on-line purchase of a good or service. Based on such data, the transaction computing device transmits a debit transaction via a debit electronic financial network (debit EFT) to a computing device of a financial institution for approval. The transaction computing device receives a response indicating whether the transaction is approved or declined by the financial institution and then notifies the merchant computing device of the approval or declination so that the commercial transaction can be completed. In addition, if the financial institution approves the transaction, the transaction computing device utilizes such approval to authenticate the user who initiated the transaction for the purpose of defining personalized data to be used to frustrate phishing by unauthorized users. In particular, if the user is authenticated, the transaction computing device allows the user to define personalized data, such as an image or phrase, unique to the user. The transaction computing device then uses the personalized data for future transactions with the user to frustrate phishing attempts. In this regard, when requesting sensitive information from the user in a future transaction, the transaction computing device causes the personalized data defined by the user to be displayed to the user so that the user is assured that the request for sensitive information is from a trusted source.

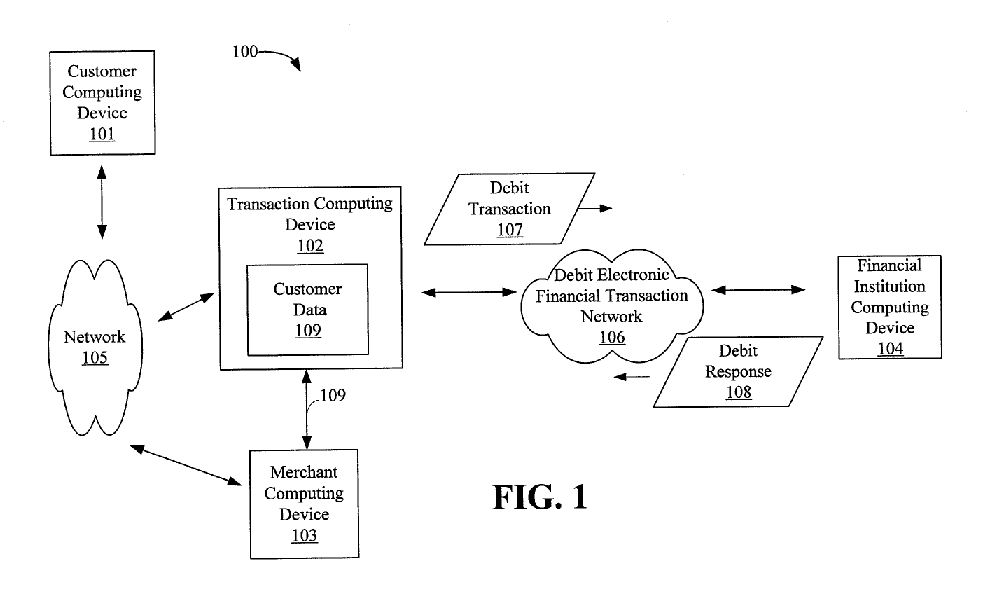

FIG. 1 depicts an exemplary on-line commercial transaction system 100. The on-line commercial transaction system 100 comprises a customer computing device 101 that is connected to a network 105. The network 105 may be, for example, the Internet.

In one embodiment, the customer computing device 101 is a personal computer (PC). However, the customer computing device 101 may be any type of device that communicatively couples to the network 105, including, for example, a laptop computer, a handheld device, a personal digital assistant (PDA), or a cell phone.

The customer computing device 101 can be any type of device that is capable of receiving data input from a user (not shown), processing the data, and transmitting the data over the network 105. In addition, the customer computing device 101 is capable of receiving data from the network 105, processing the received data, and displaying the processed data via a display device (not shown) of the customer computing device 101.

The on-line commercial transaction system 100 further comprises a merchant computing device 103 that is communicatively coupled to the network 105. The merchant computing device 103 offers for sale goods and/or services, for example, via one or more web pages (not shown). As a mere example, the merchant computing device 103 may comprise a server hosting a website that can be accessed via the customer computing device 101 and network 105 to purchase goods and/or services. The client computing device 101 communicates with the merchant computing device 103 via the network 105. For example, in one embodiment, the network 105 is the Internet and Internet protocol (IP) packets are communicated between devices 101 and 103.

The merchant computing device 103 is further connected to a transaction computing device 102 via a secure connection 109. In this regard, the merchant computing device 103 may be connected to the transaction computing device 102 via a dedicated communication network, a secured Internet connection (SSL), or a virtual private network (VPN).

The transaction computing device 102 verifies transactions between the customer computing device 101 and the merchant computing device 103. Note that the transaction computing device 102 stores customer data 109, which comprises primary account numbers (PANs) for a plurality of user's. In this regard, a user of the customer computing device 101 may use the transaction computing device 102 in performing a transaction. During the transaction, the customer enters his/her primary account number (PAN), e.g., credit card or debit card information, via a web page (not shown) maintained by the merchant computing device 103. During the verification process, the transaction computing device 102 stores the user's PAN as customer data 109.

In addition, during a transaction with the transaction computing device 102, the user has the option of registering with the transaction computing device 102. If the user registers with the transaction computing device 102, the user further provides a contact identifier, e.g., an email address and personalization data, i.e., data unique to the user. Thus, after the user registers, the transaction computing device 102 stores as customer data 109 the user's PAN, contact identifier, and personalization data. Note that personalization data is any data that is unique to the user and can include a previously selected word phrase, previously selected icon or picture, or other types of information.

In one embodiment, the transaction computing device 102 may not store the PAN but instead store a hash value indicative of the PAN. In this regard, the transaction computing device 102 may perform a one way encryption of the PAN employing any one of a number of different algorithms known in the art, or future-developed, to generate the hash value. Thereafter, the transaction computing device 102 may regenerate the PAN for future use from the hash value.

In viewing the website hosted by the merchant computing device 103, the user of the customer computing device 101 may make a selection of goods and/or services that the user desires to purchase. For example, the user may select a number of goods to be added to an electronic “shopping cart.” Once the user has completed his/her shopping, the merchant computing device 103 provides the user payment options for purchasing the selected goods.

In this regard, the merchant computing device 103 transmits data defining a web page (not shown) to the customer computing device 101. The customer computing device 101 displays the web page defined by the data via a display device (not shown). In one embodiment, the web page has a plurality of text fields or other graphical elements in which the user can enter payment information. Such payment information may include the user's name, address, and/or PAN, e.g., a credit card number, debit card number, or other sensitive information. Once the user has entered the requested information via the web page or otherwise, the customer computing device 101 transmits the payment information is transmitted to the merchant computing device 103 via the network 105.

Upon receipt of the payment information, the merchant computing device 103 sends data indicative of the PAN to the transaction computing device 102. The transaction computing device 102 initially determines if the PAN is eligible for a PIN transaction, i.e., is PIN-able. Note that a PIN transaction is a transaction wherein a debit card holder provides his/her debit card number and PIN number to purchase goods and/or services, and a financial institution, for example, approves or declines the transaction, based upon the debit card number and PIN number provided.

The transaction computing device 102 stores a plurality of bank identification numbers (BINs) obtained from a plurality of financial institutions. Each BIN is a series of numbers, for example nine (9) numbers, that identify cards that can be used with a PIN to effectuate a transaction. Notably, if any of the plurality of BINs is found in a PAN, then the card is PIN-able. Thus, the transaction computing device 102 compares a portion of the PAN received with the plurality of stored BINs. If the portion of the PAN matches one of the plurality of BINs, then the PAN is determined to be PIN-able.

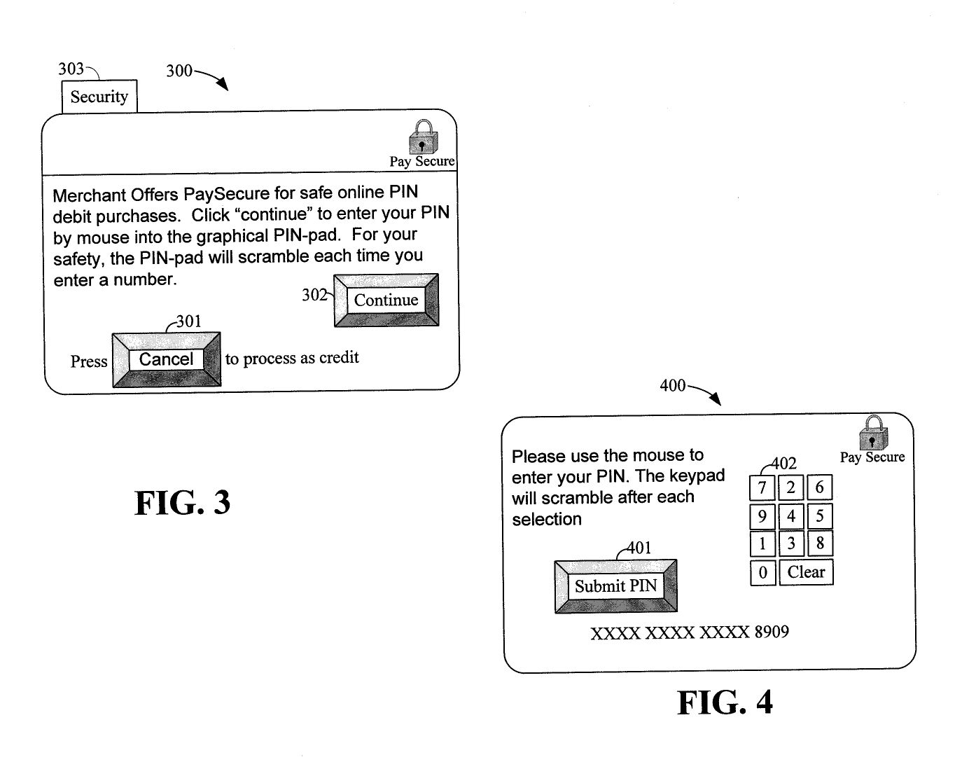

If the PAN is eligible for a PIN transaction, the transaction computing device 102 transmits data defining a graphical user interface (GUI) to the customer computing device 101 via the network 105. The GUI displayed via the customer computing device 101 prompts the user to specify whether if he/she desires to perform a debit transaction. An exemplary GUI is described further herein with reference to FIG. 3. Note that a debit transaction generally refers to a transaction in which money is withdrawn directly from a bank account or is deducted from a remaining balance on a particular card.

In one embodiment, the GUI displayed provides a security option, such as for example, the GUI displayed may have a “Security” hyperlink. If the user desires to take advantage of the security features of the system 100, the user selects the security option, e.g., selects the “Security” hyperlink, tab, or button.

If the user selects the security option, but the user has not previously used the transaction computing device 102 or has not previously registered with the transaction computing device 102, the transaction computing device 102 requests the contact identifier, e.g., an email address, from the user. As described hereinabove, the customer data 109 may comprise PAN data, the contact identifier, and personalization data for a user, if the user has used the transaction computing device 102 and previously registered.

Note that even if the user has used the transaction computing device 102 in a previous transaction, the user may not have registered. If the user has not registered, there is no contact identifier and/or personalization data corresponding to the user, e.g., there is no email address or unique data corresponding to the user stored in the customer data 109. If the user desires to use the security option, the user provides his/her contact identifier, and the transaction computing device 102 receives and stores the contact identifier along with the user's PAN. In this regard, the email address and the PAN are correlated in memory so that the device 102 may use the PAN as a key to find the contact identifier or vice versa.

Further, in performing the transaction, the transaction computing device 102 transmits data defining a PIN pad graphical user interface (GUI) to the customer computing device 101 via the network 105. Based on such data, the customer computing device 101 displays a GUI to the user. An exemplary PIN pad GUI is further described with reference to FIG. 4. The user enters his/her PIN into the PIN pad, and the transaction computing device 102 receives and stores data indicative of the PIN corresponding to the user's PAN. Various techniques for displaying a PIN pad and receiving the user's PIN are possible in other embodiments. One such technique is described in U.S. Pat. No. 6,209,104 to Jalili entitled SECURE DATA ENTRY AND VISUAL AUTHENTICATION SYSTEM AND METHOD, which is incorporated herein by reference.

After receiving the user's PIN, the transaction computing device 102 builds a debit transaction 107 based upon the PAN provided by the merchant computing device 103 and the PIN obtained from the user. The transaction computing device 102 transmits the debit transaction 107 via a debit electronic financial transaction (EFT) network 106 to a financial institution computing device 104.

Note that the debit EFT network 106 is a secured network of financial institutions. Some examples include Pulse, Nyce, Star, and Maestro. In a debit EFT network, the transaction data including the PIN data is always encrypted and access to the network is controlled and secured. In effect, it is a closed network.

In response to the debit transaction 107, the financial institution computing device 104 authenticates the user based upon the PAN and corresponding PIN number provided in the debit transaction 107. In this regard, the financial institution computing device 104 compares the provided PAN and PIN to data stored at the financial institution computing device 104. Notably, the financial institution computing device 104 determines if the PIN provided is the correct PIN for the PAN number provided, i.e., the financial institution computing device authenticates the user of the customer computing device 101. Based upon the authentication process, the financial institution computing device 104 further determines if there exists sufficient credit or funds associated with the PAN to effectuate the transaction. If the user is authenticated and there are sufficient credit or funds for the transaction, the financial institution computing device 104 transmits a debit response 108, and the debit response 108 comprises data indicating that the transaction is approved. If the user is not authenticated or there is not enough credit or funds to cover the transaction, the financial institution computing device 104 transmits the debit response 108, and the debit response 108 comprises data indicating that the transaction is declined. Note that the transaction can be declined for various reasons, but the debit transaction 107 is approved only if the user is authenticated.

Upon receipt of the debit response 108, the transaction computing device 102 transmits data indicating approval or declination to the merchant computing device 103 via the secured connection 109. In response, the merchant computing device 103 transmits via the network 105 data to the customer computing device 101 indicating that the transaction was successful or unsuccessful based upon the data received from the transaction computing device 102. Thus, the user is allowed to purchase his/her selected goods and/or services if the data received from the transaction computing device 102 indicates approval.

An exemplary authentication process is described in U.S. patent application Ser. No. 12/164,837, entitled SYSTEMS AND METHODS FOR SECURE PIN-BASED TRANSACTIONS VIA A HOST BASED PIN PAD, and filed Jun. 30, 2008, which is incorporated herein by reference.

In addition, if the debit transaction 107 is approved, the transaction computing device 102 utilizes the authentication that has occurred via the debit transaction 107 and the data indicating approval in the debit response 108 in order to authorize the user to modify his/her personalization data. In this regard, if the debit transaction 107 is approved, the transaction computing device 102 trusts the user and allows the user to add or modify personalization data.

In order to allow the user to add or modify personalization data, the transaction computing device 102 transmits a message to the contact identifier previously provided by the user. As an example, if the contact identifier is an email address, the transaction computing device 102 transmits an email message to the user using the email address previously provided by the user, as described above.

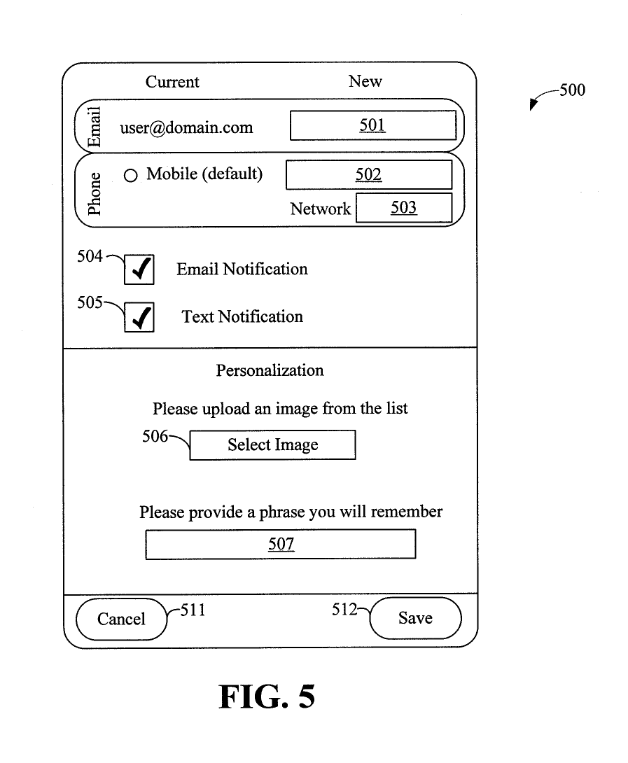

In one embodiment, the email is a single-use and/or time-sensitive email that comprises a temporary password and a uniform resource locator (URL). When the URL is selected by the user, the transaction computing device 102 transmits data indicative of a GUI that allows the user to select personalization data that is unique to the user. An exemplary GUI through which personalization data may be received is described further with reference to FIG. 5. Upon receipt of personalization data from the user, the transaction computing device 102 stores the personalization data in relation to the user's PAN and contact identifier. That is, the user's personalization data, via the user's contact identifier, is correlated with the user's PAN so that the PAN can be later used as a key to locate the user's personalization data.

Thus, for any subsequent transaction for which the user uses the transaction computing device 102, the user may elect to view the personalization data. In this regard, the user may select the security option prior to entering his/her PIN number into a PIN pad. If the user has registered, i.e., selected personalization data, the personalization data is stored corresponding to the user's PAN. Thus, when the user selects the security option, the transaction computing device 102 transmits data indicative of the user's personalization data to the customer computing device 101. Upon receipt, the customer computing device 101 displays the personalization data to the user. Therefore, by viewing the personalization data, the user is assured that he/she is dealing with a legitimate source before the user enters his/her PIN number into the PIN pad.

Note that the transaction computing device 102 protects the personalization data from unauthorized access by authenticating the user based on a debit transaction, which is highly reliable, rather than relying on the traditional user authentication to allow personalization data creation and/or modification. That is, the transaction computing device 102 uses the approval provided by the financial institution computing device 104 to authorize the user to add and/or modify his/her personalization data. This ensures that the personalization data is securely created and stored without being subject to access by individuals seeking to obtain sensitive information from the user.

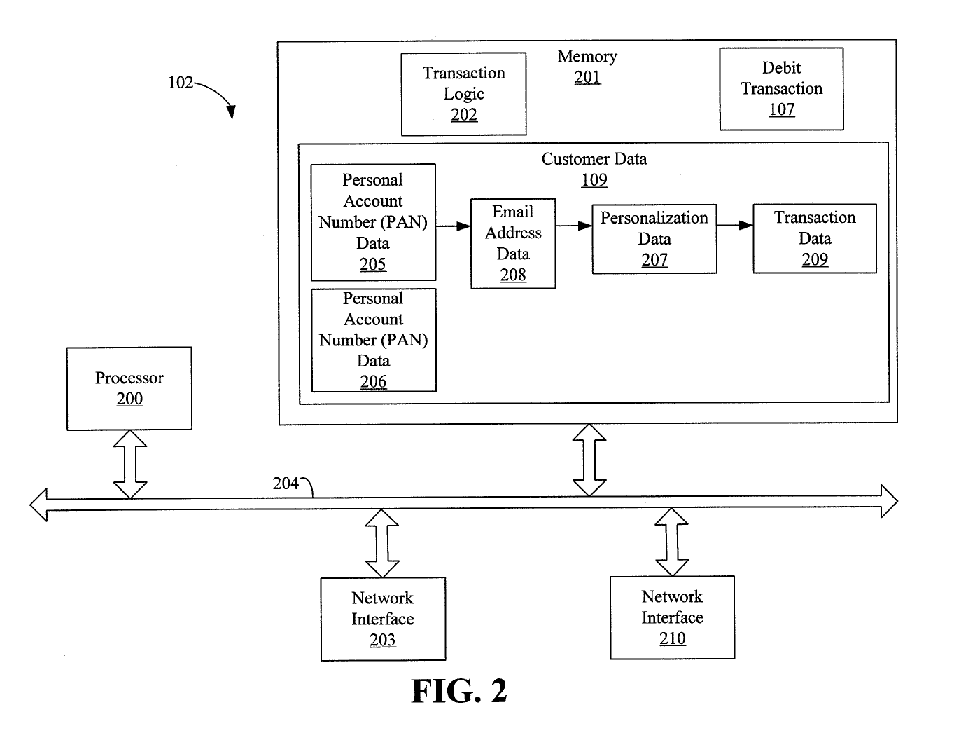

FIG. 2 depicts an exemplary embodiment of the transaction computing device 102. The transaction computing device 102 comprises transaction logic 202 for generally controlling the operation and functionality of the device 102. In the exemplary embodiment shown by FIG. 2, transaction logic 202 is implemented in software and stored in memory 201. In other embodiments, the transaction logic 202 may be implemented in firmware, hardware, or a combination of software, firmware, and/or hardware.

Further, the customer data 109 is also stored in memory 201. The customer data 109 comprises data indicative of a plurality of PANs of users who have previously used the transaction computing device 102. In FIG. 2, the customer data 109 comprises PAN data 205, 206 for users who have previously used the transaction computing device 102. In addition, associated with the PAN data there may be email address data, personalization data, and transaction data if the user associated with the PAN has previously registered with the transaction computing device 102. In FIG. 2, PAN 205 represents a PAN for one user, and PAN 206 represents a PAN for another user. The memory 201 may store many more PANs but only two are shown for brevity purposes. As shown by FIG. 2, the user associated with PAN data 205 has previously registered, or the PAN data is associated with email data 208, personalization data 207, and transaction data 209. As indicated hereinabove, in one embodiment, the personalization data 207 is indicative of a phrase, picture, and/or icon unique to the user.

The transaction data 209 is indicative of one or more previous transactions, e.g., purchases, made by the user through the transaction computing device 102. As a mere example, the transaction data 209 may specify the data and dollar amount of at least one previous transaction. The transaction data 209 may be updated each time the device 102 verifies a transaction for the user. Thus, the transaction data 209 is dynamic in the sense that each time the user makes a purchase, for example, using the transaction computing device 102, the transaction data 209 is updated.

The exemplary embodiment of the transaction computing device 102 depicted by FIG. 2 includes a processing element 200, which comprises processing hardware for executing instructions stored in memory 201. The processing element 200 communicates to and drives the other elements within the transaction computing device 102 via a local interface 204, which can include at least one bus.

Furthermore, the transaction computing device 102 comprises a network interface 203 and a network interface 210. The network interface 203 communicates over the network 105 (FIG. 1) or can establish the secure connection with the merchant computing device 103 (FIG. 1). Additionally, the network device 210 may communicate over the debit EFT network 106 (FIG. 1) for transacting with the financial institution computing device 104 (FIG. 1).

An exemplary method of using the system 100 will be described below. However, other methods are possible in other embodiments.

During operation, as described hereinabove, a user of the customer computing device 101 (FIG. 1) selects a number of goods for purchase via a web page (not shown) of the merchant computing device 103. The merchant computing device 103 obtains, via a payment information web page (not shown) or otherwise, payment information, including a user's name, address, and PAN.

The merchant computing device 103 transmits the PAN to the transaction computing device 102, which receives the PAN via the network interface 203. Upon receipt of the PAN, the transaction logic 202 determines whether the PAN can be processed as a debit transaction, i.e., whether the PAN is PIN-able as described hereinabove. In addition, the transaction logic 202 searches for the particular PAN in the customer data 109. In this regard, if the transaction logic 202 locates the PAN in the customer data 109, then the logic 202 is aware that the user has used the transaction computing device 102 previously for making a debit purchase.

If the PAN can be processed as a debit transaction, then the transaction logic 202 transmits data indicating that the PAN is PIN-able to the merchant computing device 103. In return, the merchant computing device 103 transmit data to the transaction computing device 102 indicating that the merchant computing device desires a PIN pad transaction be effectuated for the user. In response, the transaction computing device 102 transmits data that may be used to effectuate the PIN pad transaction. For example, the transaction computing device 102 may transmit to the merchant computing device 103 data indicative of a transaction identification number, a public key, a unique token and/or the last four digits of the PAN. Such data is identified for exemplary purposes only, and other data may be provided by the transaction computing device 102 in other embodiments.

To continue the process, the merchant computing device 103 transmits the data received from the transaction computing device 102 to the customer computing device 101 over the network 105. In response, the customer computing device 101 establishes a connection with the transaction computing device using the data received from the merchant computing device 103, and the transaction computing device 102 transmits data indicative of the “Continue” GUI 300 depicted in FIG. 3 to the customer computing device 101, which the customer computing device 101 displays to the user.

With reference to FIG. 3, from GUI 300, the user can select button 301 to “Cancel” and process as a credit transaction. Alternatively, the user can select push button 302 to “Continue” and process as a debit transaction.

The user can also elect to select the “Security” tab 303. If the user selects the security tab 303 and if there is no contact identifier associated with the located PAN or if the PAN was not found in the previous search by the transaction logic 202, then the transaction logic 202 displays a GUI (not shown) for discovering a contact identifier for the user. For illustrative purposes assume that the content identifier is an email address. If the user enters his/her email address into the GUI, the transaction logic 202 correlates in memory 201 the received email address with the new PAN. As described further herein, via the email address, the user is then given the option to add and/or modify personalization data after a successful debit transaction.

Once the user has entered his/her email address or has decided not to provide an email address, the user selects the “Continue” button 302. When the user selects the “Continue” button 302, the transaction logic 202 transmits data indicative of a PIN pad GUI 400, depicted in FIG. 4, to the customer computing device 101, which displays the GUI 400 to the user. The user enters his/her PIN via the PIN pad GUI 400. In this regard, the user uses a mouse (not shown) to select a combination of numbers from the plurality of number buttons 402, and then selects the button 401 to submit the PIN selected.

With further reference to FIG. 2, the transaction logic 202 receives the PIN and generates a debit transaction 107 (FIG. 1) comprising the PAN and the PIN. The transaction logic 202 transmits the debit transaction 107 to the financial institution computing device 104 (FIG. 1) through the debit network 106 via the network interface 210. The financial institution determines whether to approve or decline the transaction based upon the information contained in the debit transaction 107, the availability of funds and the legitimacy of the PIN, and transmits the debit response 108 (FIG. 1) to the transaction computing device 102 indicating that the transaction is approved or declined. The transaction computing device 102 then transmits data to the merchant computing device 103 indicating whether the debit transaction 107 is approved or declined. If it is approved, the merchant computing device 103 transmits data indicating that the debit transaction was successful and the user has purchased the requested goods and/or services. If it is declined, the merchant computing device 103 transmits data indicating that the debit transaction was unsuccessful and the user has not purchased the requested goods and/or services.

In addition, if the debit response 108 indicates that the debit transaction is approved, the transaction computing device 102 uses the approval to authenticate the user for adding personalization data if the user has not previously registered with the transaction computing device 102. If the user previously provided his/her email address as described herein, the transaction logic 202 transmits an email to the user. The email transmitted to the user requests that the user register with the transaction computing device 102 by identifying personalization data that is correlated with the user's PAN. In one embodiment, the email comprises a temporary password and a URL. When the URL is selected, the transaction computing device 102 transmits data indicative of the GUI 500 depicted in FIG. 5 to the customer computing device 101, and the customer computing device 101 displays GUI 500 to the user.

With reference to FIG. 5, GUI 500 comprises a text box 501 for entering a different email address other than the email address previously submitted. In addition, the user can enter a mobile phone number in text box 502 and select the mobile network carrier (e.g., ATT, Verizon, etc. . . . ) in text box 503. The GUI 500 further comprises check boxes 504 and 505 that the user can select if the user desires to be notified when his/her PAN number is used in a transaction. If box 504 is selected, then the user desires to be notified via email, whereas if box 505 is selected, the user desires to receive a text message.

In addition, GUI 500 receives the personalization data 207 (FIG. 2) that is unique to the user. In this regard, the user can select a unique image that the transaction logic 202 (FIG. 2) correlates with the user's PAN in memory 201 (FIG. 2). In one embodiment, the user can select the “Select Image” button 506, and when selected the transaction logic 202 transmits data indicative of a plurality of pre-determined images to the customer computing device 101, which is displayed to the user. The user selects one of the plurality of images displayed to be correlated with his/her PAN as personalization data 207 (FIG. 2).

In addition to selecting an image, the GUI 500 comprises a text box 507. In text box 507, the user enters a text phrase unique to the user.

Upon selection of the “Save” button 512, the transaction logic 202 (FIG. 2) stores data indicative of the image selected and the phrase entered in the GUI 500 as customer data 109 (FIG. 1) correlated with the user's PAN. In addition, the user can select the “Cancel” button 511 to cancel from the GUI 500.

With reference to FIG. 2, as described hereinabove, the user may have previously registered with the transaction computing device 102. In such a scenario, the transaction computing device 102 enables the user to modify the personalization data 207 based upon a debit response 108 (FIG. 1) received from the financial institution 104 (FIG. 1). The PAN 205 is indicative of a user that has previously registered, and associated with the PAN 205 is email address data 208, personalization data 207, and transaction data 209.

In such an example, the user selects a number of goods and/or services to purchase from the merchant computing device 103 (FIG. 1), and in response to a payment web page (not shown), the user enters his/her PAN number to purchase the goods and/or services selected. As described hereinabove, in response, the transaction computing device 102 displays the GUI 300 depicted in FIG. 3.

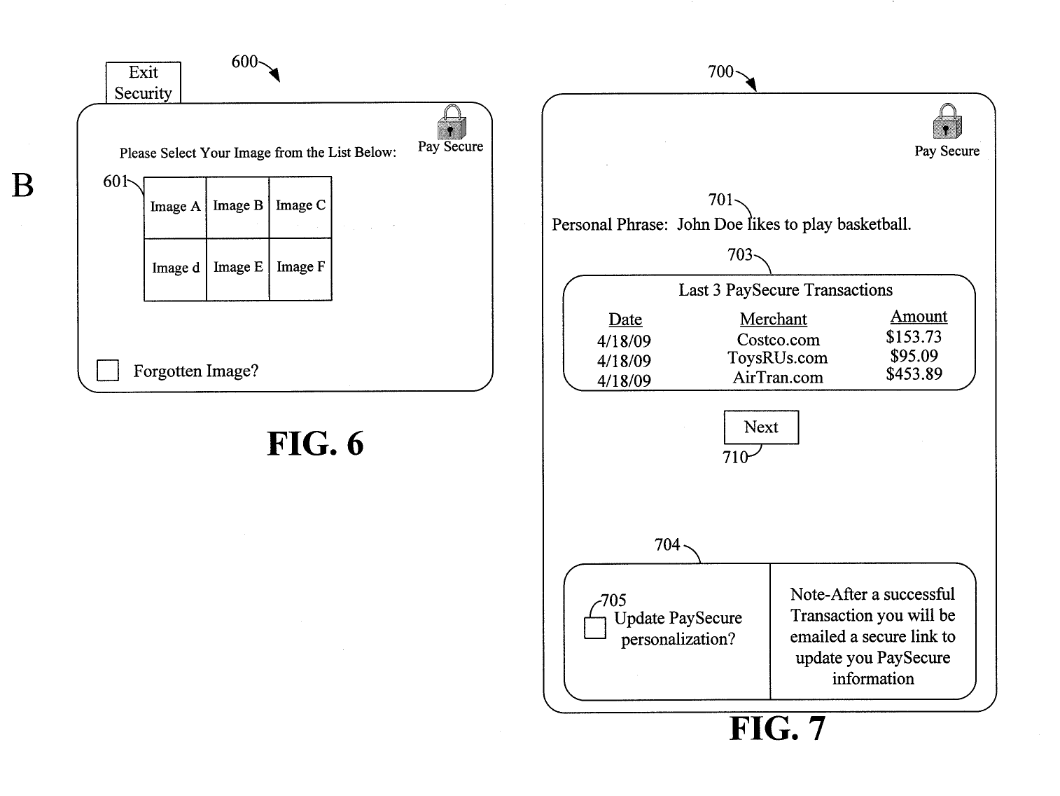

If the user has registered previously, the user may desire to verify that he/she is corresponding with a legitimate source. Therefore, the user can select the “Security” tab 303. When selected, the transaction logic 202 (FIG. 2) transmits data indicative of the GUI 600 depicted in FIG. 6 to the customer computing device 101, which the customer computing device 101 displays to the user. The GUI 600 comprises an array 601 of a plurality of images Image A through Image F. From the array 601, the user using a mouse (not shown) connected to the customer computing device 101 selects from the array 601 the image that he/she selected as his/her image during registration through GUI 500.

Note that the array 601 comprises six rectangular images Image A through Image F. However additional or fewer images in other shapes, e.g., circular, may be used in other embodiments of the present disclosure. In addition, the images Image A through Image F may be placed at any point on the GUI 600 and need not be placed as indicated in FIG. 6.

The transaction computing logic 202 receives data indicative of the image selected from the array 601 and compares the image selected with the image correlated with the current user's PAN. If the image selected is the image that the user selected as his/her image during registration, the transaction logic 202 transmits data indicative of GUI 700 (FIG. 7) to the customer computing device 101, and the customer computing device 101 displays GUI 700 to the user.

With reference to FIG. 7, the GUI 700 displays the pre-selected unique phrase 701, which in the example provided is “John Doe likes to play basketball.” Such phrase should be recognizable to the user. Therefore, upon recognizing the unique phrase 701, the user can be assured that he/she is dealing with a legitimate source.

In addition to the pre-selected unique phrase 701, transaction data 209 is displayed in the window 703. The transaction data 209 indicates recent purchases by the user. The transaction data 209 is retrieved from the customer data 109 (FIG. 1) and transmitted to the customer computing device 101, which displays the transaction data 209 in window 703. Notably, the transaction data 209, as described hereinabove, is dynamic in the sense that each time the user makes a purchase, the transaction data 209 is updated, i.e., the oldest entry in the transaction data 209 falls from the list, and the newest entry is added to the list. Thus, the most recent purchases in which the transaction computing device 102 (FIG. 1) is used are displayed to the user.

In the example provided, the transaction data 209 comprises three entries dated Apr. 18, 2009 at costco.com, ToysRUs.com, and AirTran.com for amounts of $153.73, $95.09, and $453.89, respectively. Such data should be recognizable to the user, which further affirms to the user that he/she is dealing with a legitimate source.

In addition, the transaction logic 202 displays window 704. Window 704 comprises a selection box 705. If the user desires to modify his/her pre-selected unique phrase 701 or pre-selected image 702, the user selects the selection box 705.

Notably, once a user has registered with the transaction computing device 102, the user expects to see the correct personalization data 207 (FIG. 2) displayed in FIG. 7. Thus, if the user is displayed a page without recognizable personalization data, such as during a phishing scam, the user should be suspicious that the source of the web page is not legitimate. Displaying of the image selection GUI 600 and GUI 700 enables the user to trust the source of the web page being displayed.

Once the user has selected the selection box 705, the user may desire to complete his/her transaction of purchasing goods. The user then selects the “Next” button 710, and the customer computing device 101 displays the GUI 300 depicted in FIG. 3. The user then selects the “Continue” push button 302, and enters his/her PIN in GUI 400, as described hereinabove.

In response to the user entering the PIN via the GUI 400, the transaction logic 202 creates a debit transaction 107 (FIG. 1), as described hereinabove, and transmits the debit transaction 107 to the financial institution 104 (FIG. 1) via the debit network 106 (FIG. 1). In response, the financial institution 104 transmits a debit response 108 (FIG. 1) back to the transaction computing device 102 that comprises data indicating approval or denial of the debit transaction 107.

If the transaction is approved and the user has selected the selection box 705 (FIG. 7), then the transaction logic 202 (FIG. 2) leverages off such approval by allowing the user to modify his/her personalization data. In this regard, the transaction logic 202 uses the approval from the debit response 108 to authenticate the user for updating the personalization data 207 (FIG. 2). For example, in one embodiment, the transaction logic 202 transmits an email, as described hereinabove, to the user comprising a single-use time-sensitive URL, that, when selected, displays the GUI 500 to the user. Using the GUI 500, the user can update the personalization data 207 (FIG. 2) stored on the transaction computing device 102 (FIG. 1).

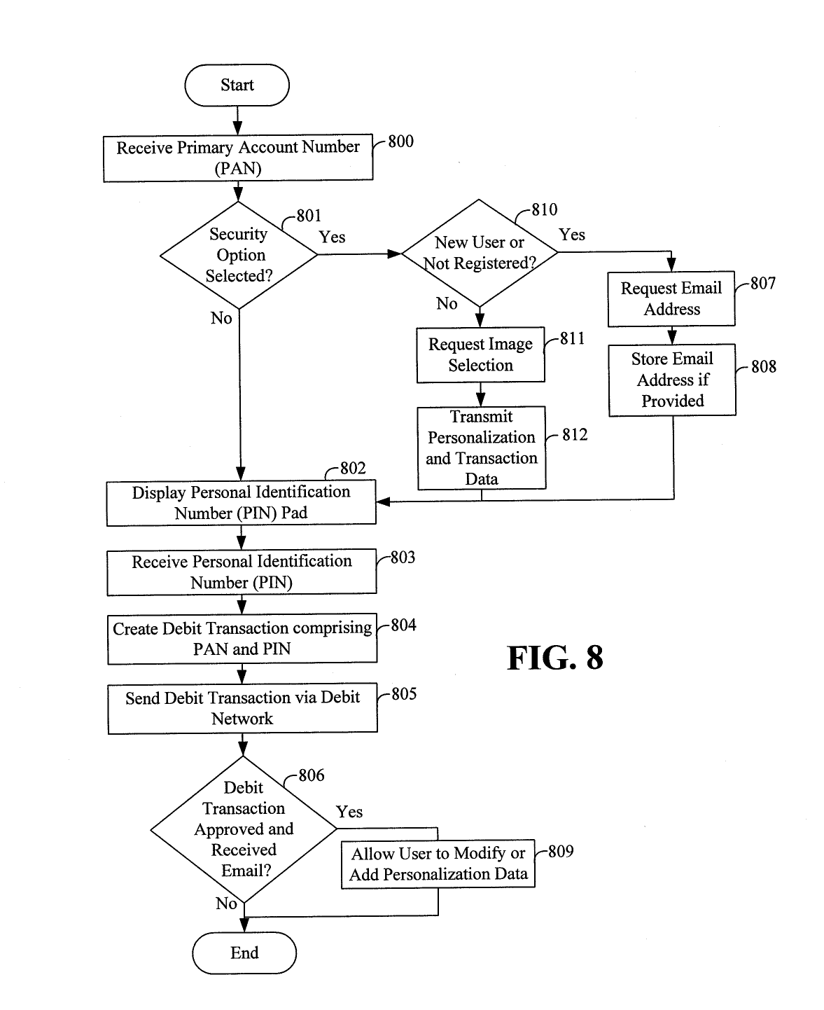

FIG. 8 is a flowchart depicting exemplary architecture and functionality of the transaction logic 202 depicted in FIG. 2. In the course of an online transaction, the merchant computing device 103 (FIG. 1) sends the transaction computing device 102 (FIG. 1) a PAN. Thus, in step 800, the transaction logic 202 initially receives the PAN.

If the security option is selected in step 801, the transaction logic 202 searches the customer data 109 (FIG. 1) for the received PAN to determine if the PAN identifies a new user an existing and registered user. If the user is new to the transaction computing device 102 and is not registered in step 810, the transaction logic 202 requests an email address from the user, as indicated in step 807, and stores the email address associated with the PAN in step 808.

If the user already exists, the transaction logic 202 requests from the user an image selection 811. In one embodiment, the customer computing device 101 displays the GUI 600 depicted in FIG. 6 that comprises an array 601 (FIG. 6) of images, and the user selects from the array 601 the image he/she selected during registration. If the correct image is selected, the transaction logic 202 transmits data indicative of the user's personalization data 207 (FIG. 2) and transaction data 209 (FIG. 2), which the customer computing device 101 displays to the user in GUI 700 (FIG. 7). Such data should be recognizable to the user so that the user knows that he/she is dealing with a legitimate source.

Once the user exits from the security option, the transaction logic 202 displays the personal identification number (PIN) pad, as indicated in step 802. In one embodiment, the PIN pad is similar to the GUI 400 depicted in FIG. 4, and the user uses a mouse (not shown) to select numbers on the PIN pad associated with the user's PIN. Once the user selects the “Submit PIN” push button 401 (FIG. 4), the transaction logic 202 receives the PIN, as indicated in step 803.

Once the transaction logic 202 has received both the PAN and the PIN of the user, the transaction logic 202 creates a debit transaction 107 (FIG. 1) comprising the PAN and the PIN, as indicated in step 804. The transaction logic 202 then transmits the debit transaction 107 to the financial institution 104 (FIG. 1) via the debit network 106 (FIG. 1).

In response to the debit transaction 107, the financial institution 104 transmits a debit response 108 (FIG. 1) to the transaction computing device 102 (FIG. 1) indicating whether the debit transaction 107 is approved or declined. If the debit transaction is approved, as indicated in step 805, then the transaction logic 202 allows the user to modify or add personalization data corresponding to the PAN number, as indicated in step 808. In this regard, the transaction logic 202 transmits an email to the user that comprises a URL that when selected displays the GUI 500 depicted in FIG. 5, which allows a user to modify or add personalization data associated with the PAN.

1. A system, comprising:
a merchant computing device communicatively coupled to a customer computing device via a network;
a transaction computing device securely coupled to the merchant computing device and coupled to a debit network; and
logic configured to enable a user of the customer computing device to create or modify personalization data stored on the transaction computing device based upon an approval obtained via the debit network during a transaction with the merchant computing device.

2. The system of claim 1, wherein the merchant computing device receives a primary account number (PAN) as payment for a purchase of selected goods.

3. The system of claim 2, wherein the logic is further configured to determine, based upon the PAN, whether the PAN can be used for a debit transaction.

4. The system of claim 3, wherein the logic is further configured to request from the user whether the user desires a debit transaction, if the PAN can be used for a debit transaction.

5. The system of claim 4, wherein the logic is further configured to receive an email address from the user and associate the email address with the PAN.

6. The system of claim 5, wherein the logic is further configured to receive a personal identification number (PIN) from the user.

7. The system of claim 6, wherein the logic is further configured to create a debit transaction comprising the PAN and the PIN and to transmit the debit transaction via the debit network.

8. The system of claim 7, wherein the logic is further configured to receive, via the debit network, a response to the debit transaction.

9. The system of claim 1, wherein the personalization data comprises a phrase and an image.

10. The system of claim 9, wherein the logic is further configured to display the phrase and the image to the user when the user performs a transaction with the transaction computing device.

11. The system of claim 9, wherein the logic is further configured to display the phrase, the image, and dynamic transaction data to the user when requested by the user.

12. The system of claim 11, wherein the dynamic transaction data displayed is data indicative of one or more recent debit transactions performed by the user.

13. A transaction computing device, comprising:
memory;
logic configured to receive commercial transaction data from a merchant computing device via a secured connection, the commercial transaction data comprising a primary account number (PAN) of a user associated with a commercial transaction, the logic configured to transmit a request for a personal identification number (PIN) of the user in response to the commercial transaction data, the logic configured to receive the PIN and to transmit a debit transaction via a debit electronic financial transaction (debit EFT) network, the debit transaction comprising the PAN and the PIN, the logic configured to receive a response via the debit EFT network indicating whether the debit transaction is approved, the logic configured to authenticate the user based on the response if the response indicates that the debit transaction is approved and to allow the user to define personalized data, the logic further configured to store the personalized data in the memory and to cause the personalized data to be displayed to the user when the logic requests sensitive information from the user for another commercial transaction associated with the user thereby assuring the user that the request for the sensitive information is from a trusted source.

14. A method, comprising:
communicatively coupling a customer computing device to a merchant computing device via a network;
securely coupling the merchant computing device to a transaction computing device;
coupling the transaction computing device to a debit network; and
enabling a user of the customer computing device to modify personalization data stored on the transaction computing device based upon an approval obtained via the debit network during a transaction with the merchant computing device.

15. The method of claim 14, further comprising receiving a primary account number (PAN) for payment of a purchase of selected goods.

16. The method of claim 15, further comprising determining, based upon the PAN, whether the PAN can be used for a debit transaction.

17. The method of claim 16, further comprising requesting from the user whether the user desires a debit transaction, if the PAN can be used for a debit transaction.

18. The method of claim 17, further comprising:
receiving an email address from the user; and
correlating the email address with the PAN.

19. The method of claim 18, further comprising receiving a personal identification number (PIN) from the user.

20. The method of claim 19, further comprising:
creating a debit transaction comprising the PAN and the PIN; and
transmitting the debit transaction via the debit network.

21. The method of claim 20, further comprising receiving, via the debit network, a response to the debit transaction.

22. The method of claim 14, wherein the personalization data comprises a phrase and an image further comprising displaying the phrase to the user based upon the user selecting one of a plurality of images displayed to the user when the user performs a transaction with the transaction computing device.

23. A method, comprising:
receiving commercial transaction data form a merchant computing device via a secured connection, the commercial transaction data comprising a primary account number (PAN) of a user associated with a commercial transaction;
transmitting a request for a personal identification number (PIN) of the user in response to the commercial transaction data;
receiving the PIN;
transmitting a debit transaction via a debit electronic financial transaction (debit EFT) network, the debit transaction comprising the PAN and the PIN;
receiving a response via the EFT network indicating whether the debit transaction is approved;
authenticating the user based on the response if the response indicates that the debit transaction is approved;
allowing, based on the authenticating, the user to define personalized data for use in future commercial transactions if the user is authenticated;
storing the personalized data in memory;
transmitting a request for sensitive information of the user; and
correlating the request for sensitive information with the personalized data such that the personalized data is displayed to the user when the user is prompted for the sensitive information thereby assuring the user that the request for sensitive information is from a trusted source.
